(19) United States
(12) Patent Application Publication
(10) Pub. No.: US 2024/0413302 A1
(43) Pub. Date: Dec. 12, 2024

(54) HIGH CAPACITIVE ELECTRODE

(71) Applicant: TOYOTA MOTOR ENGINEERING & MANUFACTURING NORTH AMERICA, INC., Plano, TX (US)

(72) Inventors: Shingo OTA, Ann Arbor, MI (US); Nikhilendra SINGH, Ann Arbor, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/329,616

(22) Filed: Jun. 6, 2023

(51) Int. Cl. H01M 4/36; H01M 4/04; H01M 4/58; H01M 4/62; H01M 10/0525

(52) U.S. Cl. CPC H01M 4/364; H01M 4/0404; H01M 4/582; H01M 4/623; H01M 4/625; H01M 10/0525; H01M 2004/027; H01M 2004/028

(57) ABSTRACT

An electrode for a solid-state metal ion battery having an active material composition containing an intimate mixture of a metal-ion active material, a metal ion salt and an iron oxyhalide compound of formula (I) is provided.

FeOX (I)

wherein X is F, Cl, Br or L. A content of the metal-ion active material, metal ion salt and compound of formula (I) is from 70 to 100 vol % of the active material composition.

### FIELD OF DISCLOSURE

This disclosure is directed to novel electrode active material compositions for solid state metal ion batteries having a significantly higher volume fraction of material capable to insert and de-insert metal ions and thus provide batteries having significantly higher capacity. In one embodiment this disclosure is directed to cathode active material compositions and cathodes constructed with the composition for solid state metal ion batteries wherein the volume fraction of material capable to insert and de-insert metal ions is 80 vol % or higher of the total cathode active material composition. In one embodiment this disclosure is directed to a cathode for a solid-state lithium-ion battery and a solid-state lithium-ion battery containing the cathode.

### BACKGROUND

Solid-state metal ion batteries and especially solid-state lithium-ion batteries are of much interest for energy storage and supply for portable devices including a gamut from mobile phones and computers to transportation vehicles. The solid-state battery offers improved safety over conventional batteries containing solvent liquid electrolytes. However, to meet increasing demand for batteries having greater electrical capacity, greater energy density, increased lifetime and temperature stability, all aspects of the structure and component compositions of solid-state batteries are under investigation. Solid-state electrolytes having high metal ion conductivity are described in copending U.S. application Ser. No. 18/310,676, filed May 2, 2023. However, in conventional solid-state metal-ion battery electrodes, especially the cathode, the active material employed to insert and de-insert the metal ion is mixed with other materials such as for example, electrolyte, conductive materials and binder to prepare the active material layer formed on a current collector. The electrolyte is added to provide metal-ion conductive pathways to transport the metal ion to and from the active material for insertion and de-insertation during the charging and discharging operation of the battery. To be effective solid electrolytes must form a continuous ion pathway which requires that the electrolyte particles form a continuous line of contact from the solid-state electrolyte separator to the particles of the active material. To form such continuous ion pathway a minimum vol % fraction of the electrolyte within the total active material layer must be approximately 30 vol % and higher vol fractions may be used. As a result, an upper limit of vol % fraction of the active material is 70% or less and therefore, the electrical capacity of the battery is limited by the amount of active material present.

Accordingly, an object of this application is to provide electrode active material compositions for solid-state metal-ion batteries having higher content of material capable to insert and de-insert metal ions.

A further object of this application is to provide electrodes, especially cathodes, for solid-state metal-ion batteries having increased energy density.

A further object of this application is to provide solid-state metal-ion batteries containing the cathodes of this disclosure having high electrical capacity.

A specific object of this application is to provide a cathode active material composition for a solid-state lithium-ion battery, a cathode for a solid-state lithium-ion battery and a solid-state lithium-ion battery having high energy density and electrical capacity.

### SUMMARY OF THE EMBODIMENTS

These and other objects are provided by the embodiments of the present disclosure, the first embodiment of which includes an electrode for a solid-state metal-ion battery, comprising: a current collector; and an active material composition on at least one surface of the current collector; wherein
the active material composition comprises an intimate mixture of at least:
an active material capable of insertion and extraction of a metal ion;
a metal ion salt of a metal selected from the group consisting of Li, Na, Mg, Zn and Al; and a compound of formula (I):

FeOX (I)
wherein X is F, Cl, Br or I, and
wherein a content of the active material, metal ion salt and compound of formula (I) is from 70 to 100 vol % of the active material composition.

In one aspect of the first embodiment an anion component of the metal ion salt is selected from the group consisting of F⁻, Cl⁻, Br⁻, I⁻, ClO₄⁻, BF₆⁻ and PF₆⁻.

In one aspect of the first embodiment a mole ratio of the metal ion salt to the FeOX is from 1/10 to 1/1.

In one aspect of the first embodiment the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO4), lithium nickel manganese cobalt oxide (NMC), elemental sulfur and a metal sulfide composite.

In one aspect of the first embodiment the current colector is selected from the group consisting of aluminum, copper, nickel, stainless steel, carbon, carbon paper and carbon cloth.

In one aspect of the first embodiment the active material composition further comprises a conductive agent selected from the group consisting of acetylene black, Ketjen black, and carbon fibers and a content of the conductive agent is 10 vol % or less of the active material composition.

In one aspect of the first embodiment the active material composition further comprises a binder selected from the group consisting of polyvinylidene fluoride (PVDF), polytetrafluoroethylene, and mixtures of styrene-butadiene-rubber (SBR) and carboxymethyl cellulose (CMC) and a mass % content of the binder is 3 mass % or less of the active material composition.

In one aspect of the first embodiment the active material composition does not comprise a binder.

In one aspect of the first embodiment a content of the active material, metal ion salt and compound of formula (I) is from 85 to 100 vol % of the active material composition.

In one special aspect of the first embodiment the electrode is a cathode for a solid-state lithium-ion battery, and the metal ion salt is at least one selected from the group consisting of LIF, LiCl, LiBr, LiI, LiClO₄, LiBF₆ and LiPF₆. In a further aspect of the cathode for a solid-state lithium-ion battery the compound of formula (I) is FeOCI.

In a further aspect of the cathode for a solid-state lithium-ion battery of the first embodiment, the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

In a second embodiment, the present disclosure provides a solid-state metal ion battery, comprising: an anode comprising an anode active material capable of insertion and extraction of at least one of Li, Na, Mg, Zn and Al; a cathode comprising a cathode active material composition capable of insertion and extraction of the at least one of Li, Na, Mg, Zn and Al; and a solid-state electrolyte between the anode and cathode which is conductive of the at least one of Li, Na, Mg, Zn and Al; wherein the cathode active material composition comprises an intimate mixture of at least:
an active material capable of insertion and extraction of Li, Na, Mg, Zn and Al;
a metal ion salt of a metal selected from the group consisting of Li, Na, Mg, Zn and Al; and a compound of formula (I):

FeOX (I)
wherein X is F, Cl, Br or I, and
wherein a content of the active material, metal ion salt and compound of formula (I) is from 70 to 100 vol % of the active material composition.

In one aspect of the second embodiment an anion component of the metal ion salt is selected from the group consisting of F⁻, Cl⁻, Br⁻, I⁻, ClO₄⁻, BF₆⁻ and PF₆⁻.

In one aspect of the second embodiment a mole ratio of the metal ion salt to the FeOX is from 1/10 to 1/1.

In one aspect of the second embodiment the cathode active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

In one aspect of the second embodiment the active material composition further comprises a conductive agent selected from the group consisting of acetylene black, Ketjen black, and carbon fibers and a content of the conductive agent is 10 vol % or less of the active material composition.

In one aspect of the second embodiment the active material composition further comprises a binder selected from the group consisting of polyvinylidene fluoride (PVDF), polytetrafluoroethylene, and mixtures of styrene-butadiene-rubber (SBR) and carboxymethyl cellulose (CMC) and a mass % content of the binder is 3 mass % or less of the active material composition.

In one aspect of the second embodiment the active material composition does not comprise a binder.

In one aspect of the second embodiment a content of the cathode active material, metal ion salt and compound of formula (I) is from 85 to 100 vol % of the cathode active material composition.

In one aspect of the second embodiment the anode active material comprises at least one selected from the group consisting of lithium metal, a lithium alloy, sodium metal, a sodium alloy, magnesium metal, a magnesium alloy, zinc metal, a zinc alloy, aluminum metal, an aluminum alloy, graphite, hard carbon, lithium titanate (LTO), a tin/cobalt alloy, silicon, indium, bismuth and a silicon/carbon composite.

In a third embodiment the present disclosure provides a solid-state lithium-ion battery, comprising: an anode having an anode active material capable of insertion and extraction of Li⁺ ions; a cathode having a cathode active material composition capable of insertion and extraction of Li⁺ ions; and a solid-state electrolyte between the anode and cathode which is conductive of Li⁺ ions; wherein
the cathode active material composition comprises an intimate mixture of at least:
an active material capable of insertion and extraction of Li;
at least one metal ion salt of lithium; and
a compound of formula (I):

FeOX (I)
wherein X is F, Cl, Br or I, and
wherein a content of the active material, at least one metal ion salt of lithium and compound of formula (I) is from 70 to 100 vol % of the active material composition, and wherein the at least one metal ion salt comprises a lithium salt selected from the group consisting of LiCl, LiClO₄, LiBF₆ and LiPF₆.

In one aspect of the third embodiment the compound of formula (I) is FeOCI.

In one aspect of the third embodiment a mole ratio of the at least one metal ion salt to the FeOX is from 1/10 to 1/1.

In one aspect of the third embodiment the cathode active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

In one aspect of the third embodiment the cathode active material composition further comprises a conductive agent selected from the group consisting of acetylene black, Ketjen black, and carbon fibers and a content of the conductive agent is 10 vol % or less of the active material composition.

In one aspect of the third embodiment the cathode active material composition further comprises a binder selected from the group consisting of polyvinylidene fluoride (PVDF), polytetrafluoroethylene, and mixtures of styrene-butadiene-rubber (SBR) and carboxymethyl cellulose (CMC) and a mass % content of the binder is 3 mass % or less of the cathode active material composition.

In one aspect of the third embodiment the cathode active material composition does not comprise a binder.

In one aspect of the third embodiment a content of the cathode active material, metal ion salt and compound of formula (I) is from 85 to 100 vol % of the cathode active material composition.

In one aspect of the third embodiment the anode active material comprises at least one selected from the group consisting of lithium metal, a lithium alloy, graphite, hard carbon, lithium titanate (LTO), a tin/cobalt alloy, silicon, indium, bismuth, and a silicon/carbon composite.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

FIG. 1 shows the relationship of metal salt content in a FeOX/metal salt composite and metal ion conductivity according to one embodiment of this disclosure.

FIG. 2 shows the relationship of FeOX particle size and metal ion conductivity for embodiments of the present disclosure.

### DESCRIPTION OF THE PREFERRED EMBODIMENTS

In ongoing studies of potential electrolytic materials, the present inventors have surprisingly discovered that novel mixtures of iron oxyhalides and metal ion salts have properties which makes the mixture suitable as a solid metal ion electrolyte including having metal-ion conductivity of 10⁻⁶ S/cm or higher at room temperature, having good stability against chemical, electrochemical and thermal degradation, high elasticity and being economical in cost. In addition, it has been determined that the intimate mixture is capable to insert and de-insert metal ions. Therefore, the utility of the intimate mixture as a component of an electrode active material composition to serve not only as an electrolyte, but also as an active material capable to insert and de-insert metal ions and to serve as a binder is disclosed.

As described in copending U.S. application Ser. No. 18/310,676, the intimate mixture of FeOX and metal salt is surprisingly elastic and exhibits a relatively low Young's modulus which allows preparation of compositions of high density. The Young's modulus of the composite of this disclosure may be in the range of from 1 to 18 GPa, preferably from 1 to 14 GPa and most preferably from 1 to 10 GPa. This elasticity allows production of electrode active material layers of high density and even allows for utility as a binder of the active material and other components of the active material composition.

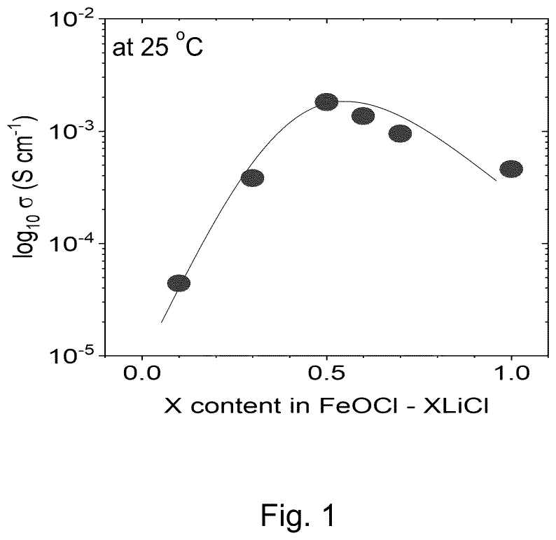

Further, the metal ion conductivity of the electrolyte composite is dependent upon the relative mole ratio of the metal salt to the FeOX. Thus, as shown in FIG. 1 for the composite of formula FeOCl—XLiCl, exemplary of the FeOX/metal ion composites of the present disclosure, there is an optimum mole ratio between a 1/10 (0.1) and 1/1 (1.0) mole content ratio of LiCl and FeOCl, preferably, 2/10 (0.2) to 8/10 (0.8) and most preferably, 4/10 (0.4) to 7/10 (0.7).

Iron oxyhalides may be obtained by heat treatment of a mixture containing an iron oxide, an iron halide and water at temperatures from 100° C. to 400° C. or by thermal decomposition of mixtures of FeX₃.6H₂O at temperatures greater than 200° C. The iron oxide may be any of FeO, Fe₂O₃ and F₃O₄. The iron halide may be any of FeF₂, FeF₃, FeF₂.hydrate, FeF₃.hydrate, FeCl₂, FeCl₃, FeCl₂.hydrate, FeCl₃.hydrate FeBr₂, FeBr₃, FeBr₂.hydrate, FeBr₃.hydrate, FeI₂, FeI₃, FeI₂.hydrate, FeI₃.hydrate. An intimate mixture of the iron oxide, iron halide and water is annealed at a temperature of 100° C. to° C. for 1 second to 1000 hours. A single phase is preferred, but a multiple phase is also acceptable. The synthesized FeOX may be rinsed with water, or an acid such as HCl or organic solvent. The solvent may be removed by heating.

Iron oxychloride may be a preferred form of FeOX and is obtained as violet opaque crystals having a layered structure which exfoliates to smaller layered particles upon mechanical treatment such as sonification. Iron oxychloride is known as a Fenton catalyst for the oxidative degradation of environmentally persistent organic materials and may be useful for applications such as wastewater treatment and soil remediation. Further, iron oxychloride has been described as a cathode active material for a chloride ion battery.

However, the inventors are aware of no prior description or use of iron oxyhalides of the formula FeOX, specifically iron oxychloride, in combination with a metal salt as a metal ion conductive material which is capable to insert and de-insert metal ions and thus serve as both electrolyte and an active material for a solid-state metal-ion battery.

Without being limited by theory, it is believed that the iron of the FeOX binds with the anion of the metal salt, which is the conductive ion source, thus freeing the metal ion for migration through the conductive channels of the composite of the intimate mixture of the FeOX exfoliate particles and metal ion salt, thus promoting high metal ion conductivity. For this reason, the FeOX may be considered a catalyst promoting metal ion conductivity and may be referenced as “catalyst” throughout the present disclosure.

Additionally, the two-dimensional layered structure of the FeOX materials wherein the layers are bonded through van der Waals forces provide space for insertion and de-insertion of metal ions and thus functions not only as an ion conductive material but also as an active material which can insert and de-insert metal ions.

Although any anion which effectively bonds with the Fe may be employed, the anions F⁻, Cl⁻, Br⁻, I⁻, ClO₄⁻, BF₆⁻ and PF₆⁻ are preferred and Cl⁻ is most preferred.

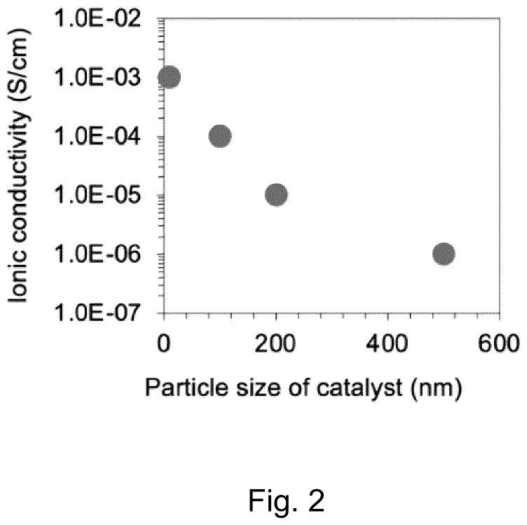

In addition, according to the present disclosure, the inventors have determined that by control of the FeOX (catalyst) particle size to 500 nm or less the conductivity may be significantly increased. For particle size of 500 nm or less the relationship of conductivity and metal ion particle size approaches an inverse linear curve as shown in FIG. 2. Thus, in preferred embodiments the FeOX particle size may be from 1 nm or less to 200 nm and in a most preferred embodiment the FeOX particle size may be from 10 nm or less to 100 nm.

FeOX of the target particle size may be prepared by dispersing the dry FeOX in acetone or a mixture of acetone and another solvent such as methyl ethyl ketone, methanol, ethanol, propanol and isopropanol, followed by sonication of the mixture until the target exfoliate particle size is obtained.

Methods to prepare the intimate mixture of the FeOX and metal ion salt are described copending U.S. application Ser. No. 18/310,676, the disclosure of which is incorporated herein by reference.

Particle size may be determined by conventional methods including laser diffraction, dynamic light scattering, and direct imaging techniques as recognized and practiced by one of skill in the art.

An electrode of the present disclosure may be prepared by dispersing the active material and the metal ion conductive composition in an appropriate solvent and applying the dispersed mixture onto a current collector. The solvent may be removed by drying and the material densified under pressure according to methods conventionally known. Other additives such as binders and conductive agents as described below may also be included in the active material composition. Standard current collector materials include but are not limited to aluminum, copper, nickel, stainless steel, carbon, carbon paper and carbon cloth.

Thus, in a first embodiment the present disclosure provides an electrode for a solid-state metal-ion battery, comprising:
a current collector; and an active material composition on at least one surface of the current collector; wherein the active material composition comprises an intimate mixture of at least:
an active material capable of insertion and extraction of a metal ion;
a metal ion salt of a metal selected from the group consisting of Li, Na, Mg, Zn and Al; and
a compound of formula (I):

FeOX (I)
wherein X is F, Cl, Br or I, and
wherein a content of the active material, metal ion salt and compound of formula (I) is from 70 to 100 vol % of the active material composition, preferably from 80 to 100 vol % and most preferably from 90 to 100 vol % of the active material composition.

Although any metal ion active material (a material capable of insertion and de-insertion of a metal ion) may be included, in preferred embodiments, the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

The active material composition may include other components conventionally employed in solid state metal ion battery electrodes as long as the other component does not impair the performance of the composition of the present disclosure. For example, the active material composition may contain one or more conventionally known conductive agents and in preferred embodiments when a conductive agent is present it is selected from the group consisting of acetylene black, Ketjen black, and carbon fibers. When present the content of the conductive agent is 10 vol % or less, preferably 8 vol % or less and most preferably 6 vol % or less.

The active material composition may include a binder. Although any binder conventionally know may be used, in preferred embodiments the binder may be selected from the group consisting of polyvinylidene fluoride (PVDF), polytetrafluoroethylene, and mixtures of styrene-butadiene-rubber (SBR) and carboxymethyl cellulose (CMC). When present the content of the binder is 3 vol % or less, preferably 2 vol % or less and most preferably 1 vol % or less. In selected preferred embodiments the FeOX-metal salt mixture may bind the active material composition and a conventional binder is not included within the composition of the active material composition.

The electrode of the present disclosure may be a cathode for a solid-state lithium-ion battery wherein the metal ion salt is one or more selected from the group consisting of LiF, LiCl, LiBr, LiI, LiClO₄, LiBF₆ and LiPF₆.

In selected preferred embodiments of the cathode for a solid-state lithium-ion battery the compound of formula (I) is FeOCl.

The active material of the cathode for a solid-state lithium-ion battery may be one or more selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite. In selected preferred embodiments the active material may be LiCoO₂, LiMn₂O_{4 or NMC.}

In a second embodiment, the present disclosure provides a solid-state metal ion battery, comprising: n anode comprising an anode active material capable of insertion and extraction of at least one of Li, Na, Mg, Zn and Al; a cathode comprising a cathode active material composition capable of insertion and extraction of the at least one of Li, Na, Mg, Zn and Al; and a solid-state electrolyte between the anode and cathode which is conductive of the at least one of Li, Na, Mg, Zn and Al; wherein the cathode active material composition comprises an intimate mixture of at least:
an active material capable of insertion and extraction of Li, Na, Mg, Zn and Al;
a metal ion salt of a metal selected from the group consisting of Li, Na, Mg, Zn and Al; and a compound of formula (I):

FeOX (I)
wherein X is F, Cl, Br or I, and
wherein a content of the active material, metal salt and compound of formula (I) is from 70 to 100 vol % of the active material composition, preferably from 80 to 100 vol % and most preferably from 90 to 100 vol % of the active material composition.

Although any anion which effectively bonds with the Fe may be employed, the anions F⁻, Cl⁻, Br⁻, I⁻, ClO₄⁻, BF₆⁻ and PF₆⁻ are preferred and Cl⁻ is most preferred.

Although any metal ion active material (a material capable of insertion and de-insertion of a metal ion) may be included, in preferred embodiments, the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

The active material composition may include other components conventionally employed in solid state metal ion battery electrodes as long as the other component does not impair the performance of the composition of the present disclosure. For example, the active material composition may contain one or more conventionally known conductive agents and in preferred embodiments when a conductive agent is present it is selected from the group consisting of acetylene black, Ketjen black, and carbon fibers. When present the content of the conductive agent is 10 vol % or less, preferably 8 vol % or less and most preferably 6 vol % or less.

The active material composition may include a binder. Although any binder conventionally know may be used, in preferred embodiments the binder may be selected from the group consisting of polyvinylidene fluoride (PVDF), polytetrafluoroethylene, and mixtures of styrene-butadiene-rubber (SBR) and carboxymethyl cellulose (CMC). When present the content of the binder is 3 vol % or less, preferably 2 vol % or less and most preferably 1 vol % or less. In selected preferred embodiments the FeOX-metal salt mixture may bind the active material composition and a conventional binder is not included within the composition of the active material composition.

Although any conventionally known anode active material may be employed within the present disclosure, in preferred embodiments the anode active material may be at least one selected from the group consisting of lithium metal, a lithium alloy, sodium metal, a sodium alloy, magnesium metal, a magnesium alloy, zinc metal, a zinc alloy, aluminum metal, an aluminum alloy, graphite, hard carbon, lithium titanate (LTO), a tin/cobalt alloy, silicon, indium, bismuth and a silicon/carbon composite.

In a third embodiment the present disclosure provides a solid-state lithium-ion battery, comprising: an anode active material capable of insertion and extraction of Li⁺ ions; a cathode active material composition capable of insertion and extraction of Li⁺ ions; and a solid-state electrolyte between the anode and cathode which is conductive of Li⁺ ions; wherein the cathode active material composition comprises an intimate mixture of at least:
an active material capable of insertion and extraction of Li ions;
at least one metal ion salt of lithium; and
a compound of formula (I):

FeOX (I)
wherein X is F, Cl, Br or I, and
wherein a content of the active material, at least one metal ion salt of lithium and compound of formula (I) is from 70 to 100 vol % of the active material composition, preferably 80 to 100 vol % and most preferably from 90 to 100 vol % of the active material composition, and wherein the at least one metal ion salt comprises a lithium salt selected from the group consisting of LiCl, LiClO₄, LiBF₆ and LiPF₆, preferably LiCl.

Preferably the compound of formula (I) is FeOCl.

A mole ratio of the at least one metal ion salt to the FeOX is from 1/10 to 1/1, preferably, 2/10 to 8/10 and most preferably, 4/10 to 7/10.

The cathode active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite, preferably LiCoO₂, LiMn₂O₄ or NMC.

The active material composition may include other components conventionally employed in solid state metal ion battery electrodes as long as the other component does not impair the performance of the present disclosure. For example, the active material composition may contain one or more conventionally known conductive agents and in preferred embodiments when a conductive agent is present it is selected from the group consisting of acetylene black, Ketjen black, and carbon fibers. When present the content of the conductive agent is 10 vol % or less, preferably 8 vol % or less and most preferably 6 vol % or less.

The active material composition may include a binder. Although any binder conventionally know may be used, in preferred embodiments the binder may be selected from the group consisting of polyvinylidene fluoride (PVDF), polytetrafluoroethylene, and mixtures of styrene-butadiene-rubber (SBR) and carboxymethyl cellulose (CMC). When present the content of the binder is 3 vol % or less, preferably 2 vol % or less and most preferably 1 vol % or less. In selected preferred embodiments the FeOX-metal salt mixture may bind the active material composition and a conventional binder is not included within the composition of the active material composition.

The anode active material comprises at least one selected from the group consisting of lithium metal, a lithium alloy, graphite, hard carbon, lithium titanate (LTO), a tin/cobalt alloy, silicon, indium, bismuth and a silicon/carbon composite.

The above description is presented to enable a person skilled in the art to make and use the embodiments and aspects of the disclosure and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. In this regard, certain embodiments within the disclosure may not show every benefit of the disclosure, considered broadly.

1. An electrode for a solid-state metal-ion battery, comprising:
a current collector; and
an active material composition on at least one surface of the current collector;
wherein
the active material composition comprises an intimate mixture of at least:
an active material capable of insertion and extraction of a metal ion;
a metal ion salt of a metal selected from the group consisting of Li, Na, Mg, Zn and Al; and
a compound of formula (I):
FeOX (I)
wherein X is F, Cl, Br or I, and
wherein a content of the active material, metal ion salt and compound of formula (I) is from 70 to 100 vol % of the active material composition.

2. The electrode for a solid-state metal-ion battery of claim 1, wherein an anion component of the metal ion salt is selected from the group consisting of F⁻, Cl⁻, Br⁻, I⁻, ClO₄⁻, BF₆⁻ and PF₆⁻.

3. The electrode for a solid-state metal-ion battery of claim 1, wherein a mole ratio of the metal ion salt to the FeOX is from 1/10 to 1/1.

4. The electrode for a solid-state metal-ion battery of claim 1, wherein the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

5. The electrode for a solid-state metal-ion battery of claim 1, wherein the current colector is selected from the group consisting of aluminum, copper, nickel, stainless steel, carbon, carbon paper and carbon cloth.

6. The electrode for a solid-state metal-ion battery of claim 1, wherein the active material composition further comprises a conductive agent selected from the group consisting of acetylene black, Ketjen black, and carbon fibers.

7. The electrode for a solid-state metal-ion battery of claim 6, wherein a content of the conductive agent is 10 vol % or less of the active material composition.

8. The electrode for a solid-state metal-ion battery of claim 1, wherein the active material composition further comprises a binder selected from the group consisting of polyvinylidene fluoride (PVDF), polytetrafluoroethylene, and mixtures of styrene-butadiene-rubber (SBR) and carboxymethyl cellulose (CMC).

9. The electrode for a solid-state metal-ion battery of claim 8, wherein a mass % content of the binder is 3 mass % or less of the active material composition.

10. The electrode for a solid-state metal-ion battery of claim 1, wherein the active material composition does not comprise a binder.

11. The electrode for a solid-state metal-ion battery of claim 1, wherein a content of the active material, metal ion salt and compound of formula (I) is from 80 to 100 vol % of the active material composition.

12. The electrode for a solid-state metal-ion battery of claim 1, wherein the electrode is a cathode for a solid-state lithium-ion battery and the metal ion salt is at least one selected from the group consisting of LiF, LiCl, LiBr, LiI, LiClO₄, LiBF₆ and LiPF₆.

13. The electrode for a solid-state metal-ion battery of claim 12, wherein the compound of formula (I) is FeOCl.

14. The electrode for a solid-state metal-ion battery of claim 12, wherein the active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

15. A solid-state metal ion battery, comprising:
an anode comprising an anode active material capable of insertion and extraction of at least one of Li, Na, Mg, Zn and Al;
a cathode comprising a cathode active material composition capable of insertion and extraction of the at least one of Li, Na, Mg, Zn and Al; and
a solid-state electrolyte between the anode and cathode which is conductive of the at least one of Li, Na, Mg, Zn and Al;
wherein the cathode active material composition comprises an intimate mixture of at least:
an active material capable of insertion and extraction of Li, Na, Mg, Zn and Al;
a metal ion salt of a metal selected from the group consisting of Li, Na, Mg, Zn and Al; and
a compound of formula (I):
FeOX (I)
wherein X is F, Cl, Br or I, and
wherein a content of the active material, metal ion salt and compound of formula (I) is from 70 to 100 vol % of the active material composition.

16. The solid-state metal-ion battery of claim 15, wherein an anion component of the metal ion salt is selected from the group consisting of F⁻, Cl⁻, Br⁻, I⁻, ClO₄⁻, BF₆⁻ and PF₆⁻.

17. The solid-state metal-ion battery of claim 15, wherein a mole ratio of the metal ion salt to the FeOX is from 1/10 to 1/1.

18. The solid-state metal-ion battery of claim 15, wherein the cathode active material comprises at least one selected from the group consisting of LiCoO₂, V₂O₅, CoSiO₄. MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

19. The solid-state metal-ion battery of claim 15, wherein the active material composition further comprises a conductive agent selected from the group consisting of acetylene black, Ketjen black, and carbon fibers.

20. The solid-state metal-ion battery of claim 19, wherein a content of the conductive agent is 10 vol % or less of the active material composition.

21. The solid-state metal-ion battery of claim 15, wherein the active material composition further comprises a binder selected from the group consisting of polyvinylidene fluoride (PVDF), polytetrafluoroethylene, and mixtures of styrene-butadiene-rubber (SBR) and carboxymethyl cellulose (CMC).

22. The solid-state metal-ion battery of claim 21, wherein a mass % content of the binder is 3 mass % or less of the active material composition.

23. The solid-state metal-ion battery of claim 15, wherein the active material composition does not comprise a binder.

24. The solid-state metal-ion battery of claim 15, wherein a content of the cathode active material, metal ion salt and compound of formula (I) is from 80 to 100 vol % of the cathode active material composition.

25. The solid-state metal-ion battery of claim 15, wherein the anode active material comprises at least one selected from the group consisting of lithium metal, a lithium alloy, sodium metal, a sodium alloy, magnesium metal, a magnesium alloy, zinc metal, a zinc alloy, aluminum metal, an aluminum alloy, graphite, hard carbon, lithium titanate (LTO), a tin/cobalt alloy, silicon, indium, bismuth and a silicon/carbon composite.

26. A solid-state lithium-ion battery, comprising:
an anode active material capable of insertion and extraction of Li⁺ ions;
a cathode active material composition capable of insertion and extraction of Li⁺ ions; and
a solid-state electrolyte between the anode and cathode which is conductive of Li⁺ ions;
wherein
the cathode active material composition comprises an intimate mixture of at least:
an active material capable of insertion and extraction of Li ions;
at least one metal ion salt of lithium; and
a compound of formula (I):
FeOX (I)
wherein X is F, CI, Br or I, and
wherein a content of the active material, at least one metal ion salt of lithium and compound of formula (I) is from 70 to 100 vol % of the active material composition, and
wherein the at least one metal ion salt comprises a lithium salt selected from the group consisting of LiCl, LiClO₄, LiBF₆ and LiPF₆.

27. The solid-state lithium-ion battery of claim 26, wherein the compound of formula (I) is FeOCl.

28. The solid-state lithium-ion battery of claim 26, wherein a mole ratio of the at least one metal ion salt to the FeOX is from 1/10 to 1/1.

29. The solid-state lithium-ion battery of claim 26, wherein the cathode active material comprises at least one selected from the group consisting of LiCoO₂, V₂O₅, CoSiO₄, MoO₃, CoSiO₄, sulfur, Mo₆S₈, Al₂O₃, TiS₂, lithium manganese oxide (LiMn₂O₄), lithium iron phosphate (LiFePO₄), lithium nickel manganese cobalt oxide (NMC), elemental sulfur and a metal sulfide composite.

30. The solid-state lithium-ion battery of claim 26, wherein the cathode active material composition further comprises a conductive agent selected from the group consisting of acetylene black, Ketjen black, and carbon fibers.

31. The solid-state lithium-ion battery of claim 30, wherein a content of the conductive agent is 10 vol % or less of the active material composition.

32. The solid-state lithium-ion battery of claim 26, wherein the cathode active material composition further comprises a binder selected from the group consisting of polyvinylidene fluoride (PVDF), polytetrafluoroethylene, and mixtures of styrene-butadiene-rubber (SBR) and carboxymethyl cellulose (CMC).

33. The solid-state lithium-ion battery of claim 32, wherein a mass % content of the binder is 3 mass % or less of the cathode active material composition.

34. The solid-state metal-ion battery of claim 26, wherein the cathode active material composition does not comprise a binder.

35. The solid-state lithium-ion battery of claim 26, wherein a content of the cathode active material, metal ion salt and compound of formula (I) is from 80 to 100 vol % of the cathode active material composition.

36. The solid-state metal-ion battery of claim 26, wherein the anode active material comprises at least one selected from the group consisting of lithium metal, a lithium alloy, graphite, hard carbon, lithium titanate (LTO), a tin/cobalt alloy, silicon, indium, bismuth and a silicon/carbon composite.
